(19) United States
(12) Patent Application Publication
(10) Pub. No.: US 2010/0053547 A1
(43) Pub. Date: Mar. 4, 2010

(54) Optical Article Comprising an Anti-Smudge Coating

(75) Inventors: Dominique Baude, Charenton Le Pont (FR); Caroline Jousselin, Charenton Le Pont (FR)

Correspondence Address: FULBRIGHT & JAWORSKI L.L.P., 600 CONGRESS AVE., SUITE 2400, AUSTIN, TX, 78701, US

(73) Assignee: Essilor International (Compagnie Generate d'Optique), Charenton Le Pont (FR)

(21) Appl. No.: 12/513,128

(22) PCT Filed: Oct. 31, 2007
(86) PCT No.: PCT/EP07/61769

§ 371 Date: Apr. 30, 2009

(30) Foreign Application Priority Data
Oct. 31, 2006 (FR) 06/54663

(51) Int. Cl. G02C 7/02; C08G 77/24; B32B 3/10; B32B 27/06; B05D 5/06; G02B 1/10

(52) U.S. Cl. 351/159; 528/42; 428/195.1; 428/448; 427/164; 359/507

(57) ABSTRACT

An optical article comprising an optically transparent substrate with a main surface and, covering the main surface, an anti-smudge coating itself at least partially covered by a temporary topcoat, the anti-smudge coating being the result of the hardening of a polymerisable composition comprising: 55% to 80% by weight, preferably to by weight, of a first component A selected among fluorinated compounds, of which only one end of the chain comprises at least one silanol group or silanol precursor and their mixtures, and 45% to 20% by weight of a second component B selected among linear fluorinated compounds, preferably perfluorinated compounds, of which both ends of the chain comprise at least one silanol group or silanol precursor and their mixtures, for 100% by weight of the first component A and the second component B. The first component A and the second component B together accounting for at least 50% by weight of the total weight of the coating. Application to ophthalmic lenses.

This invention relates, in general, to an optical article, particularly an ophthalmic lens, and more particularly an ophthalmic lens for eyewear, having an anti-smudge coating (top-coat) with improved anti-smudge properties that are preserved even when a temporary topcoat previously deposited on the anti-smudge coating is removed.

These anti-smudge coatings, also called “hydrophobic and/or oleophobic coatings”, are well known in the art, and are generally formed by conventional techniques of evaporation in a vacuum. They are generally manufactured from fluorosilanes or fluorosilazanes, that is, silanes and silazanes containing fluorine atoms.

Fluorosilanes particularly suited to producing anti-smudge coatings are those containing fluoropolyether groups described in U.S. Pat. No. 6,277,485.

These fluorosilanes are given by the general formula:

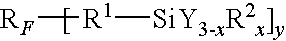

in which R_{F} is a monovalent or divalent polyfluoropolyether group, R¹ is a divalent alkylene, arylene or a combination of these two, optionally containing one or several heteroatoms or functional groups and optionally substituted by one or several halogens, and preferably containing 2 to 16 carbon atoms; R² is a lower alkyl group (that is, an alkyl group in C₁-C₄); Y is a halogen atom, a lower alkoxy group (that is, an alkoxy group in C₁-C₄, preferably methoxy or ethoxy), or a lower acyloxy group (that is, —OC(O)R³ where R³ is an alkyl group in C₁-C₄); x is 0 or 1; an y is 1 (R_{F} is monovalent) or 2 (R_{F} is divalent). Suitable compounds generally have an average number molecular weight of at least 1000. Preferably, Y is a lower alkoxy group and R_{F} is a perfluoropolyether group.

Other recommended fluorosilanes are those with the formula:

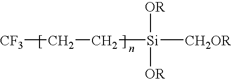

where n=5, 7, 9 or 11 and R is an alkyl group, preferably in C₁-C₁₀ such as —CH₃, —C₂H₅ and —C₃H₇;

CF₃(CF₂)₅CH₂CH₂Si(OC₂H₅)₃ ((tridecafluoro-1,1,2,2-tetrahydro)octyl-triethoxysilane);

CF₃CH₂CH₂SiCl₃;

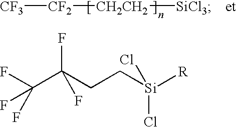

where n=7 or 9 and R is as defined above.

Compositions containing fluorosilanes also recommended for the preparation of hydrophobic and/or oleophobic top-coats are described in U.S. Pat. No. 6,183,872. They contain fluoropolymers with organic groups carrying silicon-based groups represented by the following general formula and with a molecular weight of 5·10² to 1·10⁵:

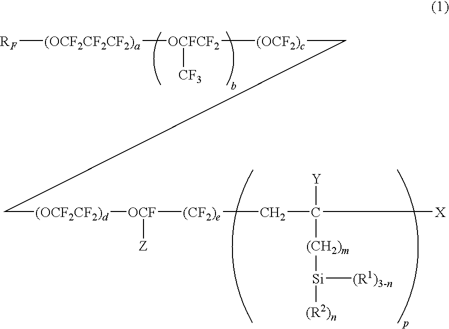

in which R_{F} represents a perfluoroalkyl group; Z represents a fluoro or trifluoromethyl group; a, b, c, d and e each representing, independently from each other, 0 or an integer greater than or equal to 1, provided that the sum a+b+c+d+e is not less than 1 and that the order of the repeated units between the brackets indexed under a, b, c, d and e are not limited to the one given; Y represents H or an alkyl group comprising from 1 to 4 carbon atoms; X represents an atom of hydrogen, bromine or iodine;

R¹ represents an hydroxyl group or a hydrolysable group; R² represents an atom of hydrogen or a monovalent hydrocarbon group; m represents 0, 1 or 2; n represents 1, 2 or 3; and p represents an integer equal to at least 1, preferably equal to at least 2.

A formulation containing a fluorosilane given by the previous formula (1) is marketed by DAIKIN INDUSTRIES with the name OPTOOL DSX®.

The published patent application US-2005/0168685 describes anti-smudge coatings formed from two or more types of silane compound selected so that each independently gives a different dynamic friction coefficient on the surface of the lens after treatment at least one or several of these species being fluorinated compounds of silane, so as to make the lens surface sufficiently non-slippery, so that it can be edged.

In a preferred embodiment, at least one of the species comprises the fluorinated compounds of silane given by the previous formula (1).

The document JP 2005 187936 describes fluorinated compounds of silane suitable for forming anti-smudge coatings and particularly compounds given by the formula:

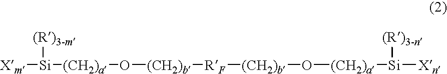

wherein
R′_{F} is a linear chain divalent perfluoropolyether radical,
R′ is an alkyl radical in C₁-C₄ or a phenyl radical,
X′ is a hydrolysable group,
a′ is an integer from 0 to 2,
b′ is an integer from 1 to 5, and
m′ and n′ are integers equal to 2 or 3.

A fluorosilane compound given by the formula (2) above is marketed by SHIN-ETSU CHEMICAL CO, Ltd with the name KY-130®.

Fluorosilane compounds given by the formula (2) and methods for preparing them are also described in the patent application EP 1 300 433.

An ophthalmic lens is the result of a series of moulding and/or surfacing/polishing operations which determine the geometry of the two convex and concave optical surfaces of the lens, followed by appropriate surface treatments.

The last step in finishing an ophthalmic lens is the edging operation which consists in machining the edge or perimeter of the lens so as to shape it to the required dimensions to fit the lens to the eyewear frame in which it is to be mounted.

The edging is generally done on a grinding wheel comprising of diamond grinding discs which carry out the machining as defined above.

The lens is held, during this operation, by blocking devices that hold it axially.

The relative movement of the lens in relation to the grinding wheel is controlled, generally numerically, in order to produce the desired shape.

As becomes apparent, it is absolutely mandatory to hold the lens firmly during this movement.

In order to do this, before the edging operation, a fixing operation is carried out on the lens, that is, a means of holding the lens known as a chuck is placed on the convex surface of the lens.

An adhesive holding pad, such as an adhesive patch, preferably a double-sided adhesive, is placed between the chuck and the convex lens surface.

The lens prepared in this way is placed on one of the axial blocking devices mentioned above, the second axial blocking device then comes to hold the concave surface via a stop, that is generally made of elastomer.

During the machining, a tangential torque is generated on the lens, which can cause the lens to rotate compared to the chuck if the system for holding the lens is not effective enough.

In order to hold the lens firmly in position, the main factor is the good adhesion of the holding pad/convex lens surface interface.

When the edging is carried out satisfactorily, the lens has the required dimensions for inserting it into the frames for which it was made. More specifically, this result is obtained when the lens, during the edging operation, undergoes a maximum offset of 2°.

The new generation of ophthalmic lenses usually have hydrophobic and/or oleophobic anti-smudge coatings associated with antireflective coatings.

One of the problems created by this type of surface coating is that the adhesion at the adhesive pad/convex surface interface is impaired.

So it becomes very difficult to carry out satisfactory edging operations, particularly for polycarbonate lenses, the edging of which requires much more effort than for other matters.

The results of a badly done edging operation is quite simply that the lens is totally lost.

To solve this problem, it has been suggested, particularly in the European patent EP 1 392 613, to cover the anti-smudge coating with a temporary topcoat. After edging the lens, this topcoat must be removed to leave the anti-smudge coating apparent.

Although fluorosilane-based anti-smudge coatings of prior art are satisfactory, it would nevertheless be desirable to have anti-smudge coatings with improved properties, particularly as to the static contact angle with water and the ability to be cleaned, and which retains these improved properties after a temporary topcoat for edging has been applied and removed.

The object of the present invention is thus an optical article, particularly an ophthalmic lens, particularly for eyewear, comprising an anti-smudge coating with improved properties, particularly an increased static contact angle with water and an ability to be cleaned at least equivalent to that of anti-smudge coatings of prior art, and which retains these improved properties after a temporary topcoat for edging has been applied and removed.

The optical article according to the invention comprises an optically transparent substrate with a main surface and, covering the main surface, an anti-smudge coating itself partly covered by a temporary topcoat and characterised by the fact that the anti-smudge coating is the result of the hardening of a polymerisable composition comprising:
55% to 80% by weight, preferably 60 to 70% by weight, of a first component A selected among fluorinated compounds, preferably perfluorinated compounds, of which only one end of the chain comprises at least one silanol group or silanol precursor and their mixtures, and
45% to 20% by weight, preferably 40% to 30% by weight, of a second component B selected among linear fluorinated compounds, preferably linear perfluorinated compounds, of which both ends of the chain comprise at least one silanol group or silanol precursor and their mixtures, for 100% by weight of the first component A and of the second component B,
the first component A and the second component B together accounting for at least 50%, and preferably at least 60% by weight of the total weight of the coating.

The invention also concerns an optical article as defined above from which the temporary topcoat has been removed.

The invention also concerns an optical article comprising an optically transparent substrate with at least a main surface covered with an anti-smudge coating and characterised by the fact that the anti-smudge coating is the result of the hardening of a polymerisable composition comprising:
55% to 80% by weight, preferably 60 to 70% by weight, of a first component A selected among fluorinated compounds, preferably perfluorinated compounds, of which only one end of the chain comprises at least one silanol group or silanol precursor and their mixtures, and
45% to 20% by weight, preferably 40% to 30% by weight, of a second component B selected among linear fluorinated compounds, preferably linear perfluorinated compounds, of which both ends of the chain comprise at least one silanol group or silanol precursor and their mixtures, for 100% by weight of the first component A and of the second component B,
the first component A and the second component B together accounting for at least 50%, and preferably at least 60% by weight, more preferably 70%, and still more preferably 80% by weight of the total weight of the coating.

In a preferred embodiment of the invention, the optical article comprises an anti-reflective coating placed between the main surface and the anti-smudge coating, the anti-smudge coating being directly deposited on the external surface of the antireflective coating. Preferably, the external surface of the antireflective coating is the external surface of a layer of SiO₂ or containing SiO₂.

In another preferred embodiment, the optical article comprises an anti-abrasion and/or anti-scratch coating under the anti-reflective coating and optionally an anti-shock primer coating between the anti-abrasion and/or anti-scratch coating and the substrate.

In the present application, the term optically transparent substrate includes all substrates conventionally used in optics, including ophthalmic optics, whether the substrate is bare or coated with one or more conventional functional coatings other than an anti-smudge coating.

The term external surface of a coating or a layer as used herein is understood to mean the surface of the coating or of the layer the furthest away from the main substrate.

The first component A is a fluorinated compound or mixture of fluorinated compounds, preferably linear, of which only one end of the chain comprises at least one silanol group or silanol precursor and which, preferably, has no reactive group likely to attach itself to the surface of the substrate or of a functional coating interposed between the substrate and the anti-smudge layer, other than the silanol or silanol precursor group or groups at the sole end of the chain.

The first components A of the anti-smudge coating are preferably selected from among perfluoropolyethers and more preferably from among compounds of the formula:

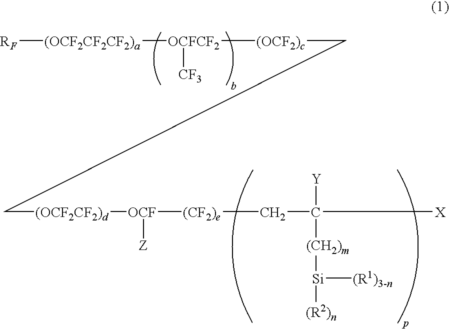

wherein
R_{F} represents a straight or branched chain perfluoroalkyl group with 1 to 16 carbon atoms,
X is an iodine or hydrogen atom,
Y is a hydrogen atom or a straight or branched alkyl group with 1 to 6 carbon atoms,
Z is a fluorine atom or a trifluoromethyl group,
R¹ is a hydrolysable group,
R² is a hydrogen atom or an inactive monovalent group,
a, b, c and d are integers from 0 to 200,
e is 0 or 1,
m and n are integers from 0 to 2, and
p is an integer from 1 to 10,

Among the preferred R_{F} groups, mention can be made of CF₃—, C₂F₅— and C₃F₇—.

R¹ is a hydrolysable group and preferably a halogen atom, particularly a chlorine atom, a —OR³, —OCOR³, —OC(R³)═C(R⁴)₂, —ON═C(R³)₂ or —ON═CR⁵ group where R³ is a aliphatic or aromatic hydrocarbon group, R⁴ is a hydrogen atom or an aliphatic hydrocarbon group in C₁-C₆, and R⁵ is a divalent aliphatic hydrocarbon group in C₃-C₆.

The particularly preferred R¹ hydrolysable groups are Cl, —OCH₃ and OC₂H₅.

R² is a hydrogen atom or an inactive monovalent organic group, and preferably a monovalent organic group in C₁-C₄.

Each of a, b, c, and d is preferably an integer from 1 to 50.

Preferably, m and n are equal to 0.

In general, the perfluoropolyethers of formula (1) have a average number molecular weight of 5×10² to 1×10⁵ g/mole, preferably 5×10² to 1×10⁴ g/mole.

The perfluoropolyethers of the component A are preferably given by the formula:

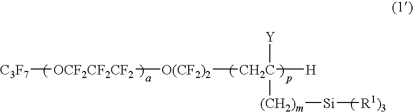

wherein Y, R¹, m and p are as defined above and a is an integer from 1 to 50.

As indicated above, the second component B of the anti-smudge coating is a compound or mixture of compounds selected among linear fluorinated compounds, preferably linear perfluorinated compounds, of which both ends of the chain comprise at least one silanol group or silanol precursor.

Preferably, the compounds of component B are selected among perfluoropolyethers.

Among the compounds preferred for component B, mention can be made of perfluoropolyethers given by the formula:

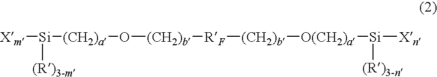

wherein
R′_{F} is a linear chain divalent perfluoropolyether radical,
R′ is an hydrocarbon radical in C₁-C₈ or a phenyl radical,
X′ is a hydrolysable group,
a′ is an integer from 0 to 2, preferably equal to 1,
b′ is an integer from 1 to 5, preferably equal to 3, and
m′ and n′ are integers equal to 2 or 3, preferably equal to 3.

Preferably the divalent perfluoropolyether radical R′_{F} is a linear divalent perfluoropolyalkyleneether particularly given by the formula

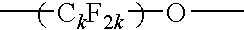

wherein k is an integer from 1 to 6.

Preferably R′ is an alkyl radical in C₁-C₄.

The hydrolysable group X′ comprises the alkoxy radicals such as methoxy, ethoxy, propoxy and butoxy, the alkoxyalkoxy radicals such as methoxymethoxy and methoxyethoxy, the acyloxy radicals such as acetoxy, the alkenyloxy radicals such as isopropenoxy, and the halogens such as chloro, bromo and iodo.

The hydrolysable groups X′ can also be the same as those mentioned for the hydrolysable groups R¹ of the compounds of formula (1).

The preferred hydrolysable groups X′ are the alkoxy and alkylenoxy groups such as the methoxy, ethoxy and isopropenoxy groups and the chloro group.

Preferably R′ is an alkyl radical in C₁-C₄ or phenyl, preferably a methyl, ethyl or phenyl radical, and more preferably a methyl radical.

The perfluoropolyethersilane compounds of formula (2) generally have an average number molecular weight from 500 to 20,000 g/mole, preferably from 1000 to 10,000 g/mole.

As an example of compounds of formula (2), mention can be made of:

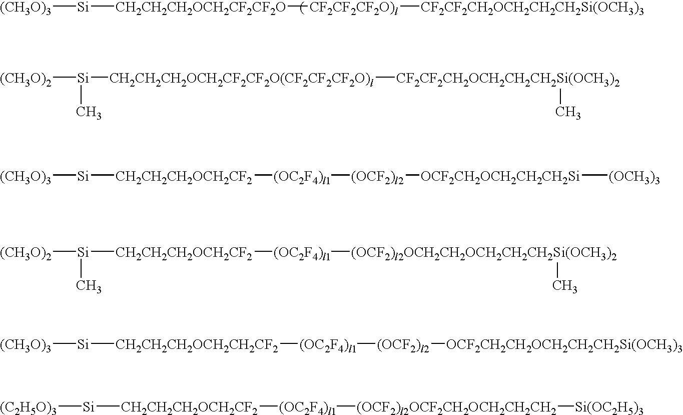

where I is an integer from 1 to 50, I₁ is an integer from 1 to 50, I₂ is an integer from 1 to 50, and I₁+I₂ equals 10 to 100, and the arrangement of the units motifs is random.

Another class of compounds suitable for component B according to the invention are compounds described in the document EP 0 797 111 and given by the formula:

R″_{F}[CO—R″—R′″—Si(OR^{iv})₃]₂

wherein
R″_{F} is a divalent perfluoropolyether group, as defined above for R′_{F},
R″ is a divalent atom or group, preferably an atom or group of atoms of O, NH, S etc. other than carbon,
R′″ is a hydrocarbon group preferably having from 2 to 10 carbon atoms, such as methylene, ethylene, propylene and phenylene,
R^{iv} is an alkyl group, preferably in C₁ to C₃.

The polyethers modified by fluoro-, preferably perfluoro-, silanes of component B are preferably prepared by addition reaction of a hydrosilane with a hydrolysable radical to a fluoro-, preferably a perfluoro-, polyether with α unsaturation at each extremity of the chain in presence of a catalyst of the platinum group according to a conventional hydrosilylation procedure.

A reagent, fluoro-, preferably perfluoro-, polyether with α unsaturation at each extremity of the chain can be synthesised by reacting, at both extremities of the chain a fluoro-, preferably perfluoro-, polyether modified by an alcohol at both extremities of the chain with an alkali metal such as K, Na or Li or a hydroxide of an alkali metal such as KOH, NaOH or LiOH to produce a fluoro, preferably a perfluoro, polyether with a alcoholate group at each extremity of the chain and making it react with a halide comprising an unsaturation in α position.

The anti-smudge coating according to the invention can comprise, apart from components A and B, additives without silicon atoms, that are an integral part of the coating but which form no chemical bonds with the surface of the substrate or an interposed functional coating. These additives may be present up to 30% by weight compared with the total weight of components A and B and of the additives. These additives are particularly perfluoropolyethers free from silicon atoms.

These perfluoropolyethers with no silicon atoms are preferably those that have a unit with no silicon atoms represented by the following structural formula:

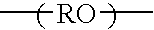

wherein R represents a perfluoroalkylene group with 1 to 3 carbon atoms. These perfluoropolyethers preferably have an average molecular weight from 1,000 to 10,000, and preferably from 2,000 to 10,000. R represents a perfluoroalkylene group in C₁-C₃ and particularly —CF₂—, —CF₂CF₂—, —CF₂CF₂CF₂— and —CF(CF₃)CF₂—. These perfluoropolyethers are liquid at normal temperature and are generally called fluorocarbonated oils. Examples of these perfluoropolyethers are marketed with the names DEMNUM® by DAIKIN INDUSTRIES LTD, BARRIERTA® by NOK KIWBERCO LFD, FOMBLIN® by ASAHI GLASS CO LTD, KRYTOX®, by EI DUPOT DE NEMOURS and COMPANY and MOLYKOTE® by DOW CORNING CORP.

The anti-smudge coating can also comprise synthesis reaction by-products of compounds of components A and B.

In general the anti-smudge coating has a thickness from 0.1 nm to 5 μm, preferably from 1 to 100 nm, more preferably less than 10 nm and better still less than 5 nm.

The anti-smudge coating can be formed by any well-known techniques such as brush coating, dip coating, centrifuging, spray coating and evaporation. Preferably the anti-smudge coating is formed by deposit by evaporation.

In these deposit operations, components A and B can be used as they are or diluted with an appropriate solvent.

Among the solvents suitable for diluting components A and B, mention can be made of fluoro-modified aliphatic hydrocarbons (e.g.: perfluoroheptane and perfluorooctane), fluoro-modified aromatic hydrocarbons (e.g.: xylene hexafluoride and benzene trifluoride), fluoro-modified ethers (e.g.: methylperfluorobutylether and perfluoro(butyl)-2-tetrahydrofurane), fluoro-modified alkylamines (e.g.: perfluorotributylamine and perfluorotripentylamine), hydrocarbons (e.g. petroleum benzene, mineral spirits, toluene and xylene), ketones (e.g.: acetone, methylethylketone and methylisobutylketone).

Among the solvents suitable for diluting components A and B, mention can be made of fluoro-modified aliphatic hydrocarbons (e.g.: perfluoroheptane and perfluorooctane), fluoro-modified aromatic hydrocarbons (e.g.: xylene hexafluoride and benzene trifluoride), fluoro-modified ethers (e.g.: methylperfluorobutylether and perfluoro(butyl)-2-tetrahydrofurane), fluoro-modified alkylamines (e.g.: perfluorotributylamine and perfluorotripentylamine), hydrocarbons (e.g. petroleum benzene, mineral spirits, toluene and xylene), ketones (e.g.: acetone, methylethylketone and methylisobutylketone).

If necessary, a condensation catalyst for hydrolys is of fluorinated silanes can be added. Among these catalysts, mention can be made of organic tin compounds (e.g.: dimethoxydibutyltin and dibutyltin dilaurate), organic compounds of titanium (e.g.: tetra-n-butyl titanate), organic acids (e.g.: acetic acid and sulphonic methane acid) and inorganic acids (e.g. hydrochloric acid and sulphuric acid). The catalyst is generally added in the proportion of 0.01 to 5 parts, preferably 0.1 to 1 part by weight for 100 parts by weight of components A and B.

The anti-smudge layers of the invention have a surface energy of 14 mJ/m² or less, preferably 13 mJ/m² or less and more preferably 12 mJ/m² or less.

The surface energies are calculated according to the OWENS-WENDT method described in reference: “Estimation of the surface force energy of polymers” OWENS D. K, WENDT R. G. (1969) J. APPL-POLYM-SCI, 13, 1741-1747.

The temporary topcoat can be inorganic or organic.

In a preferred embodiment, the temporary topcoat is an inorganic layer, and particularly a metal fluoride or a mixture of metal fluorides, a metal oxide or a mixture of metal oxides.

As an example of the fluorides, mention can be made of magnesium fluoride MgF₂, lanthanum fluoride LaF₃, aluminium fluoride AlF₃ or cerium fluoride CeF₃. Preferably, magnesium fluoride is used.

Useable oxides are titanium, aluminium, zirconium or praseodymium oxides.

Mixtures of alumina and praseodymium oxide are recommended.

A particularly recommended commercial material is the PASO2 made by LEYBOLD.

A mixture of inorganic fluorides and oxides can also be used.

The temporary topcoat can also be organic, particularly polymer-based materials.

Examples of the polymer materials suitable for the temporary topcoat include marking inks for progressive ophthalmic lenses and/or resins containing the binder of the inks and alkyd resins.

Mention can also be made of halogenated polymers, particularly chlorinated and/or fluorinated polymers, particularly chlorinated polyolefin resins (e.g.: a chlorinated polypropylene resin), the polyalkylene terephthalates (e.g.: polyethyleneterephthalate) and their mixtures. These materials are described in the international application WO 2005/015270.

Temporary topcoats and the procedures for depositing and removing them are described in European patent EP 1 392 613.

The temporary topcoat can be single layer or multi-layer.

In particular, the temporary topcoat can include a metallic fluoride, preferably MgF₂, onto which is deposited a layer of a non-fluorinated metal oxide or hydroxide, preferably MgO or Mg(OH)₂ or more preferably MgO.

Some of the ways this oxide or hydroxide layer can be deposited include evaporation or transfer from an electrostatic film.

The temporary topcoats, particularly multi-layers, and treatment of temporary topcoats are described in the patent application FR 2 856 056.

Preferably, the temporary topcoat raises the surface energy of the article to at least 15 mJ/m², preferably to a value of at least 25 mJ/m². Typically, the surface energy of the topcoat is 15 to 70 mJ/m², preferably 25 to 70 mJ/m².

The temporary topcoat can be deposited by any suitable conventional procedure.

Generally, since anti-reflective and anti-smudge coatings are deposited in vacuum domes, it is desirable to deposit the temporary topcoat by the same technique, which makes it possible to carry out all the operations in sequence, without excessive handling of the lenses between the stages.

The thickness of the temporary topcoat can vary from 1 nm to 150 μm.

When it is comprised of inorganic material, the thickness of the temporary topcoat is preferably less than or equal to 50 nm, and generally from 1 to 50 nm, and more preferably from 5 to 50 nm.

In general, if the temporary topcoat is not thick enough, the surface energy is likely not to be modified sufficiently.

If, on the contrary, the temporary topcoat is too thick, particularly for mainly inorganic topcoats, the inventors have found that mechanical constraints are likely to appear within the topcoat, which may be detrimental to the expected properties.

Preferably, and particularly when the protective temporary topcoat is deposited on the whole of one of the faces of the lens, the material presents a certain degree of transparency that makes it possible to carry out conventional power measures on the lens using a tocimeter.

Thus the lens coated with the topcoat according to the invention preferably exhibits a transmission of at least 18%, preferably at least 40% according to the standard ISO8980/3.

In the case of organic materials, particularly polymer materials, it is preferable to deposit much greater thicknesses than in the case of purely inorganic coats.

The thicknesses required can then vary from 5 to 150 micrometers.

In general, the substrate of the optical article according to the invention can be any substrate, and preferably an organic glass substrate, for example a thermoplastic or thermosetting plastic matter.

Among the plastic material suitable for substrates, mention can be made of (meth)acrylic (co)polymers, in particular poly(methyl methacrylate) (PMMA), thio(meth)acrylic (co)polymers, polyvinylbutyral (PVB), polycarbonates (PC), polyurethanes (PU), poly(thiourethanes), polyol allylcarbonates (co)polymers, thermoplastic vinyl ethylene/acetate copolymers, polyesters such as poly(ethylene terephthalate) (PET) or poly(butylene terephthalate) (PBT), polyepisulphides, polyepoxides, polycarbonate/polyester copolymers, cyclo-olefin copolymers such as ethylene/norbornene copolymers or ethylene/cyclopentadiene copolymers and combinations of these.

The term (co)polymer as used herein is understood to mean a copolymer or a polymer. The term (meth)acrylate as used herein is understood to mean an acrylate or a methacrylate.

The preferred substrates according to the invention include substrates obtained by polymerisation of alkyl (meth)acrylates, particularly alkyl (meth)acrylates in C₁-C₄, such as methyl (meth)acrylate and ethyl (meth)acrylate, polyethoxylated aromatic (meth)acrylates such as polyethoxylated bisphenol di(meth)acrylates, allyl derivatives such as linear or branched aliphatic or aromatic polyol allylcarbonates, thio(meth)acrylates, episulphides and precursory mixtures of polythiols/polyisocyanates (for obtaining polythiourethanes).

The term polycarbonate (PC) as used in the present invention is understood to include homopolycarbonates, copolycarbonates and sequenced copolycarbonates. The polycarbonates

are available commercially, for example from GENERAL ELECTRIC COMPANY with the brand name LEXAN®, TEIJIN with the brand name PANLITE®,

BAYER with the brand name BAYBLEND®, MOBAY CHEMICHAL Corp. with the brand name MAKROLON® and DOW CHEMICAL Co. with the brand name CALIBRE®.

Examples of polyol allyl carbonate (co)polymers include (co)polymers of ethyleneglycol bis(allyl carbonate), diethyleneglycol bis 2-methyl carbonate, diethyleneglycol bis(allyl carbonate), ethyleneglycol bis(2-chloro allyl carbonate), triethyleneglycol bis(allyl carbonate), 1,3-propanediol bis(allyl carbonate), propyleneglycol bis(2-ethyl allyl carbonate), 1,3-butenediol bis(allyl carbonate), 1,4-butenediol bis(2-bromo allyl carbonate), dipropyleneglycol bis(allyl carbonate), trimethyleneglycol bis(2-ethyl allyl carbonate), pentamethyleneglycol bis (allyl carbonate), isopropylene bisphenol A bis(allyl carbonate).

Particularly recommended substrates are substrates obtained by copolymerisation of diethyleneglycol bis allyl carbonate, sold, for example, with the brand name CR-39® by PPG Industries (ORMA® ESSILOR lenses).

Particularly recommended substrates include substrates obtained by polymerisation of thio(meth)acrylic polymers, such as those described in the application for the French patent FR 2734827.

Obviously, the substrates can be obtained by polymerisation of mixtures of the above monomers, or may also comprise mixtures of these polymers and (co)polymers.

It is conventional in the domain of ophthalmic lenses to coat the surface of the substrate with one or several functional coatings.

These functional coatings used conventionally in optics can be, without limitation, an anti-shock primer coating, an anti-abrasion and/or anti-scratch coating, a polarised coating, a photochromic coating, an antistatic coating or a coloured coating, or an anti-reflective coating.

Conventionally, an ophthalmic lens comprises, starting from the substrate, optionally an anti-shock primer coating, a hard anti-abrasion and/or anti-scratch coating, and on the hard coating an anti-reflective coating.

Although the anti-smudge coating can be formed directly on the main surface of the substrate or on the external surface of any of the functional coatings, particularly the anti-abrasion and/or anti-scratch coating, it is preferably formed on the external surface of the antireflective coating.

The anti-abrasion and/or anti-scratch coating can be any layer conventionally used as an anti-abrasion and/or anti-scratch coating in the domain of ophthalmic lenses.

Coatings resistant to abrasion and/or scratches are preferably hard poly(meth)acrylate- or silane-based coatings generally comprising one or several mineral loads intended to increase the hardness and/or the refractive index of the coating once it is hardened.

Hard anti-abrasion and/or anti-scratch coatings are preferably produced from formulations comprising at least one alkoxysilane and/or a hydrolysate of the latter, obtained for example by hydrolysis with a solution of hydrochloric acid. After the hydrolysis stage, the duration of which is generally comprised between 1 hour and 24 hours, preferably between 2 hours and 6 hours, condensation and/or hardening catalysts can optionally be added. A tensioactive compound is also preferably added in order to enhance the optical quality of the deposit.

Examples of recommended coatings in the present invention include epoxysilane hydrolysate-based coatings such as those described in FR 2702486 (EP 0614957), U.S. Pat. No. 4,211,823 and U.S. Pat. No. 5,015,523.

Many examples of useable condensation and/or hardening catalysts are given in “Chemistry and Technology of the Epoxy Resins”, B. Ellis (Ed.) Chapman Hall, New York, 1993 and “Epoxy Resins Chemistry and Technology” 2^{ème} edition, C. A. May (Ed.), Marcel Dekker, New York, 1988.

A formulation for a preferred anti-abrasion and/or anti-scratch coating is that disclosed in the patent FR 2702486 in the name of the applicant. It comprises a hydrolysate of epoxy trialkoxysilane and dialkyl dialkoxysilane, colloidal silicon and a catalytic quantity of aluminium-based hardening catalyst such as aluminium acetylacetonate, the rest being essentially composed of solvents conventionally used for such formulations. Preferably, the hydrolysate used is a hydrolysate of γ-glycidoxypropyltrimethoxysilane (GLYMO) et de dimethyldiethoxysilane (DMDES).

The formulation of the anti-abrasion and/or anti-scratch coating can be deposited on the main surface of the substrate by dip coating or centrifuging. It is then hardened in the appropriate way (preferably thermally or using UV).

The thickness of the anti-abrasion and/or anti-scratch coating generally varies from 2 to 10 μm, preferably from 3 to 5 μm.

Before depositing the anti-abrasion and/or anti-scratch coating, it is possible to deposit on the substrate a primer coating that improves the resistance to shocks and/or the adherence of the subsequent layers in the final product.

This coating can be any anti-shock primer layer conventionally used for articles in transparent polymer material, such as ophthalmic lenses.

The preferred primer formulations can include thermoplastic polyurethane-based formulations, such as those described in Japanese patents JP 63-141001 and JP 63-87223, poly(meth)acrylic primer formulations, such as those described in the U.S. Pat. No. 5,015,523, thermosetting polyurethane-based formulations such as those described in the patent EP 0404111 and poly(meth)acrylic latex-based formulations or polyurethane-type latex-based formulations, such as those described in the U.S. Pat. No. 5,316,791 and EP 0680492.

Preferred formulations of primer are polyurethane-based formulations and latex-based formulations, particularly polyurethane latexes.

Poly(meth)acrylic latexes are copolymer latexes mainly comprised of a (meth)acrylate, such as for example ethyl, butyl, methoxyethyl or ethoxyethyl (meth)acrylate, with a generally minor proportion of at least one other co-monomer, such as styrene for example.

Preferred poly(meth)acrylic latexes are acrylate-styrene copolymer latexes. Such acrylate-styrene copolymer latexes are commercially available from ZENECA RESINS with the name NEOCRYL®.

Polyurethane latexes are also known and available commercially. As an example, polyurethane latexes containing polyester motifs can be mentioned. Such latexes are also marketed by ZENECA RESINS with the name NEOREZ® and by BAXENDEN CHEMICALS with the name WITCOBOND®.

Commercial primer formulations suitable for the invention include Witcobond® 232, Witcobond® 234, Witcobond® 240, Witcobond® 242, Neorez® R-962, Neorez® R-972, Neorez® R-986 and Neorez® R-9603.

Mixtures of these latexes can also be used in these primer formulations, and particularly polyurethane latex and poly(meth)acrylic latex.

These primer formulations can be deposited on the faces of the article by dipcoating or centrifuging then dried at a temperature of at least 70° C. and optionally up to 100° C., preferably at around 90° C., for a duration of from 2 minutes to 2 hours, generally of the order of 15 minutes, in order to form layers of primer with a thickness, after firing, of from 0.2 to 2.5 μm, preferably from 0.5 to 1.5 μm.

An anti-reflective coating, generally deposited on the anti-abrasion and anti-scratch coating, is defined as a coating deposited on the surface of an optical article, which improves the anti-reflective properties of the article. It makes it possible to reduce the light reflected at the article/air interface over a relatively large portion of the visible spectrum.

The anti-reflective coating is generally applied by depositing it in a vacuum according to one of the following methods: i) by evaporation, optionally assisted by an ionic beam; ii) by spraying by ion beam; iii) by cathode sputtering; iv) by plasma assisted chemical deposit in vapour phase.

As well as these vacuum deposit methods, it is possible to deposit a multi-layer anti-reflective coating in wet conditions, particularly by centrifugal deposit of liquid formulations containing a hydrolysate of silanes and colloidal materials with high or low refractive index. A coating of this type the layers of which comprise a silane-based hybrid organic/inorganic matrix in which colloidal materials are dispersed making it possible to adjust the refractive index of each layer is described for example in the patent FR 2858420.

However, an anti-reflective coating comprising only a stack of mineral dielectric layers is preferred. It preferably comprises a stack of at least three dielectric layers presenting alternating HI and LI layers.

Anti-reflective coatings are well known and conventionally comprise a single layer or multi-layer stack of dielectric materials such as SiO, SiO₂, Al₂O₃, MgF₂, LiF, Si₃N₄, TiO₂, ZrO₂, Nb₂O₅, Y₂O₃, HfO₂, Sc₂O₃, Ta₂O₅, Pr₂O₃, or their mixtures.

As is also well known, anti-reflective coatings are preferably multi-layer coatings comprising alternatively high refractive index (HI) layers and low refractive index (LI) layers. Advantageously, LI layers of the anti-reflective coating comprise a mixture of SiO₂ and Al₂O₃.

In the present application, a layer of an anti-reflective stack is known as a high refractive index layer when its refractive index is higher than 1.55, preferably higher than or equal to 1.6, more preferably higher than or equal to 1.8 and still more preferably higher than or equal to 2.0. A layer of an anti-reflective stack is known as a low refractive index layer when its refractive index is lower than 1.55, preferably lower than or equal to 1.50, more preferably lower than or equal to 1.45.

Unless otherwise specified, the refractive indices referred to in the present invention are given at 25° C. for a wavelength of 550 nm.

Preferably, the total physical thickness of the anti-reflective coating is less than 1 micrometre, more preferably less than or equal to 500 nm and still more preferably less than or equal to 250 nm. The total physical thickness of the anti-reflective coating is generally over 100 nm, preferably over 150 nm.

The LI layers are also well known and may comprise, without limitation, SiO₂, MgF₂, ZrF₄, AlF₃, chiolite (Na₃Al₃F₁₄]), cryolite (Na₃[AlF₆]), and their mixtures, preferably SiO₂ or SiO₂ doped with alumina, which helps increase the thermal resistance of the anti-reflective coating. Obviously, mixtures of these compounds with optionally one or several other materials selected from among the dielectric materials previously described in the present description are such that the refractive index of the resulting layer is as defined above (<1.55).

When a LI layer comprising a mixture of SiO₂ and Al₂O₃ is used, it preferably comprises from 1 to 10%, more preferably from 1 to 8% and still more preferably from 1 to 5% by weight of Al₂O₃ compared with the total weight of SiO₂+Al₂O₃ in this layer. Too high a proportion of alumina can be detrimental to the adherence of the anti-reflective coating and to the its optical properties.

For example, SiO₂ doped with 4% or less of Al₂O₃ by weight, or SiO₂ doped with 8% of Al₂O₃ may be used. Commercially available SiO₂/Al₂O₃ mixtures may be used, such as LIMA® marketed by Umicore Materials AG (refractive index n=1.48-1.50 at 550 nm), or the substance L5® marketed by Merck KGaA (refractive index n=1.48 at 500 nm).

According to a preferred embodiment, at least one LI layer of the multi-layer stack comprises a mixture of SiO₂ and Al₂O₃, and preferably consists of a mixture of SiO₂ and Al₂O₃. According to another preferred embodiment, all the LI layers of the multi-layer stack comprise a mixture of SiO₂ et d'Al₂O₃, and preferably consist of a mixture of SiO₂ and Al₂O₃.

Generally, the physical thickness of the HI layers varies from 10 to 120 nm, and the physical thickness of the LI layers varies from 10 to 100 nm.

Preferably again, the multi-layer stack comprises at least two low refractive index layers (LI) and at least two high refractive index layers (HI). Preferably, the total number of layers in the multi-layer stack is less than or equal to 8, preferably less than or equal to 6.

It is not necessary for the HI and LI layers to alternate in the stack, although they may do so according to one embodiment of the invention. Two HI layers (or more) can be deposited one upon the other, just as two LI layers (or more) can be deposited one upon the other. Thus it is advantageous in terms of resistance to abrasion to stack one upon the other for example a HI layer of ZrO₂ and a HI layer of TiO₂ rather than using a TiO₂ layer in the place of these two adjacent HI layers.

HI layers are conventional high refractive index layers, well known in the art. They generally comprise one or several inorganic oxides such as, without limitation, zirconia (ZrO₂), titanium oxide (TiO₂), tantalum pentoxide (Ta₂O₅), neodymium oxide (Nd₂O₅), praseodymium oxide (Pr₂O₃), praseodymium titanate (PrTiO₃), La₂O₃, Dy₂O₅, Nb₂O₅, Y₂O₃. Optionally, the high index layers can also contain silica and alumina, as long as their refractive index is higher than 1.55, preferably higher than or equal to 1.6, more preferably higher than or equal to 1.7 and still more preferably higher than or equal to 1.9. The preferred materials are TiO₂, PrTiO₃, ZrO₂ and mixtures of these.

In one preferred embodiment of the invention, the anti-smudge coating is deposited on the external layer of an anti-reflective stack and this external layer comprises SiO₂ or a mixture of SiO₂+Al₂O₃, preferably comprises SiO₂ or a mixture of SiO₂+Al₂O₃, more preferably is comprised of SiO₂.

The following examples illustrate the present invention. In these examples, all percentages and quantities are expressed by weight unless otherwise indicated.

### EXAMPLE

On an anti-reflective coating of ORMA® lenses already provided with an anti-abrasion and/or anti-scratch coating (HC) and an anti-reflective coating, an anti-smudge coating according to the invention and for comparison an anti-smudge coating formed only from the product OPTOOL DSX® and an anti-smudge coating formed only from product KY-130® was deposited. The static contact angle with water was measured and the ease of cleaning (cleanability) was determined of the lenses obtained in this way.

Next a temporary topcoat was formed on the lenses, then after edging and removing the temporary topcoat the static contact angle with water and the ease of cleaning were measured once again.

The operating parameters for depositing the different layers are described below.

The results are given in Table 1 below.

Forming the Anti-Abrasion and/or Anti-Scratch Coating

80.5 parts of 0.1 N hydrochloric acid are introduced dropwise into a solution containing 224 parts of GLYMO (γ-glycidoxypropyltrimethyloxysilane) and 120 parts of DMDES (dimethyldiethoxysilane).

The hydrolysed solution is agitated for 24 hours at ambient temperature then 718 parts of 30% colloidal silica in methanol, 15 parts of aluminium acetylacetonate and 44 parts of ethylcellosolve are added.

A small quantity of tensioactive agent is added.

The theoretical dry extract of the formulation contains about 13% of solid matter from the hydrolysed DMDES.

The formulation is applied onto ORMA® lenses made of organic glass comprised of a diethylene glycol di(allylcarbonate) polymer, with a thickness of 2 mm at the centre by dipcoating. Next the lenses are subjected to pre-heating for 15 minutes at 60° C., then put in an oven at 100° C. for 3 hours.

Forming the Anti-Reflective and Anti-Smudge Coating.

The lenses coated with an anti-abrasion and/or anti-scratch coating are then placed in a SATIS 1200 machine for vacuum processing which has an END HALL MARK 2 COMMONWEALTH electron gun and a Joule effect evaporation source.

A secondary vacuum is created by pumping the substrates without heating them.

Using the electron gun, 4 high index(HI)/low index(LI)/HI/LI anti-reflective optic layers are evaporated successively: ZrO₂, SiO₂, ZrO₂, SiO₂.

Next an anti-smudge coating is deposited by evaporation either of a mixture comprised of component A and component B (2/3 OPTOOL DSX®+⅓ KY-130®) according to the invention, or of component A alone (OPTOOL DSX®), or of component B alone (KY130®), according to the following operating parameters.

The product, in liquid form, is poured into a copper capsule, then the liquid is dried off at 90° C. at atmospheric pressure.

The copper capsule is then placed in a Joule effect crucible. The product is evaporated in a secondary vacuum.

The thickness of the deposited layer is less than 10 nm.

The thickness of the deposited layer is monitored using a quartz balance.

Depositing the Temporary Topcoat

The material deposited is a compound with the formula MgF₂, with a granulometry of 1-2.5 nm, marketed by MERCK.

Evaporation is carried out with an electron gun.

The physical thickness deposited is 20 nm, at a deposit rate of 0.8 nm/s.

The thickness of the deposited layer is monitored using a quartz balance.

Next MgO is deposited by evaporation directly onto the MgF₂ layer.

An electron gun is used to evaporate, in a vacuum, a layer of MgO (starting from MgO granules (reference 700428) made by UMICORE) at a thickness equal to 2 nm, directly onto the MgF₂ layer.

After reestablishment of atmospheric pressure into the processing chamber, the lenses are recovered with their temporary topcoats in place.

Removing the Temporary Topcoat.

The topcoat is removed manually, without moisture, using a WYPALL type wipe.

Results of the Static Contact Angle with Water and Cleanability Measurements.

TABLE 1

| | Before depositing the | | After depositing and removing | |
|---|---|---|---|---|
| | temporary topcoat | | the temporary topcoat | |
| Anti-smudge | Contact angle | Clean- | Contact angle | Clean- |
| coating | with water (°) | ability | with water (°) | ability |
| KY-130 ® | 110 | 3.5 | 110.5 | — |
| (comparative) | | | | |
| ⅓KY- | 116.1 | 2.5 | 115.1 +± 10.6 | 2.9 |
| 130 ® + ⅔ | | | | |
| OPTOOL | | | | |
| DSX ® | | | | |
| OPTOOL | 118 | 2.3-2.5 | 113.5 | 2.9 |
| DSX ® | | | | |
| (comparative) | | | | |

From the table, it is surprising to see that the anti-smudge coating according to the invention shows, after depositing and removing the temporary topcoat, a contact angle with water higher than that of coatings formed either from the OPTOOL DSX® product alone or from the KY 130® product alone. Moreover, the cleanability remains high, practically equal to that obtained with the pure product OPTOOL DSX® alone before depositing the topcoat and after depositing and removing it.

Cleanability Test

The test is carried out on the lenses before depositing the temporary topcoat and on the lenses from which the temporary topcoat has been removed.

The lenses used have a curvature radius comprised between 80 and 180 mm and a diameter of 65 to 70 mm.

The cleaning test consists in depositing about 50 micrograms of dirt in the form of a 20 mm stain (this is an artificial stain, comprising mostly oleic acid) on the convex surface of the ophthalmic lens (or lens) and to carry out reproducible wiping with a back and forth movement (one back and forth movement corresponding by definition to two wipes) with a cotton cloth (made by Berkshire) under a load of 750 g.

The total amplitude when the cloth moves on the lens is 40 mm, i.e. 20 mm on each side of a point centred on the stain.

After each wiping cycle, the scattering value of the lens is measured.

The scattering measurement is carried out with a Hazeguard XL 211 Plus device.

Then the number of wipes needed to create a scattering level of the lens lower than or equal to 0.5% is determined.

The wiping cycle is as follows:

Cycle Number of Wipes

| CYCLE | NUMBER OF WIPES |
|---|---|
| 1 | 2 |
| 2 | 10 |
| 3 | 20 |
| 4 | 40 |
| 5 | 70 |
| 6 | 100 |
| 7 | 150 |
| 8 | 200 |

For recommencing the following cycle, after the scattering measurement, the same cloth is used, disposed in the same way as initially.

The number of wipes to obtain a scattering value is determined by the calculation, using the number of wipes around the value 0.5% and the real values of diffusion obtained.

H0: initial scattering value of the lens

NS1: Maximum number of wipes leading to scattering of over 0.5%

H1: Scattering value corresponding to NS1

NS2: Maximum number of wipes leading to scattering of less than 0.5%

H2: Scattering value corresponding to NS2

Number of wipes=NS1+[[(H1−H0)−0.5]x[(NS2−NS1)/(H1−H0)− (H2−H0))]

The cleanability score is the natural logarithm of the number of wipes: Ln (number of wipes),

The lower the score, the better the cleanability.

Measuring the Static Contact Angle with Water

This measurement is carried out by automatic acquisition and by image analysis of the contact angle of a drop of water deposited on the surface of a flat or curved lens with the purpose of evaluating the hydrophobic performance of a treatment.

The measurement is carried out on a DSA100 (Drop Shape Analysis System) Kruss device linked to a Windows PC.

The volume of the drop formed is 4 microlitres.

The conductivity of the water is comprised between 0.3 μS and 1 μS at 25° C.

The temperature of the room is maintained at 23+/−5° C.

1.-22. (canceled)

23. An optical article comprising an optically transparent substrate with a main surface and an anti-smudge coating covering the main surface, wherein the anti-smudge coating is the result of the hardening of a polymerizable composition, comprising:
55% to 80% by weight of a first component A selected from fluorinated compounds of which only one end comprises at least one silanol group or silanol precursor or mixture of such compounds; and
45% to 20% by weight of a second component B selected from linear fluorinated compounds of which both ends comprise at least one silanol group or silanol precursor or mixture of such compounds relative to the weight of compounds A and B comprised in said polymerizable composition;
wherein first component A and second component B together account for at least 50% by weight of the total weight of the coating.

24. The optical article of claim 23, wherein the polymerizable composition comprises 60 to 70% by weight of first component A.

25. The optical article of claim 23, wherein the polymerizable composition comprises 40% to 30% by weight of second component B.

26. The optical article of claim 23, wherein first component A and second component B together account for at least 60% by weight of the total weight of the coating.

27. The optical article of claim 23, wherein first component A and/or second component B are selected from perfluorinated compounds.

28. The optical article of claim 27, wherein first and second components A and B comprise perfluoropolyethers.

29. The optical article of claim 23, wherein first component A is comprised of a fluorinated compound or mixture of fluorinated compounds with no reactive group likely to attach itself to the surface of the substrate or of a functional coating interposed between the substrate and the anti-smudge layer, other than the silanol or silanol precursor group or groups at the end of the chain only.

30. The optical article of claim 29, wherein first component A is comprised of a linear fluorinated compound or mixture of linear fluorinated compounds.

31. The optical article of claim 23, wherein first component A comprises a compound of formula: 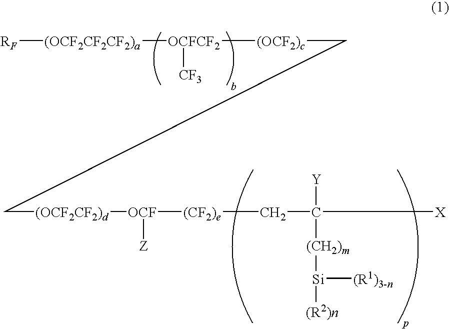
wherein
R_{F} is a straight or branched chain perfluoroalkyl group with 1 to 16 carbon atoms;
X is an iodine or hydrogen atom;
Y is a hydrogen atom or a straight or branched alkyl group with 1 to 6 carbon atoms;
Z is a fluorine atom or a trifluoromethyl group;
R¹ is a hydrolysable group;
R² is a hydrogen atom or an inactive monovalent group;
a, b, c and d are integers from 0 to 200;
e is 0 or 1;
m and n are integers from 0 to 2; and
p is an integer from 1 to 10.

32. The optical article of claim 23, wherein the first component A comprises a compound of formula: 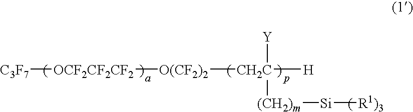
wherein
Y is a hydrogen atom or an alkyl radical with 1 to 6 carbon atoms;
R¹ is a hydrolysable group;
a is an integer from 1 to 50;
m is an integer from 0 to 2; and
p is an integer from 1 to 10.

33. The optical article of claim 32, wherein:
the hydrolysable groups X′ are halogen atoms, —OR³, —OCOR³, —OC(R³)═C(R⁴)₂, —ON═C(R³)₂ and/or —ON═CR⁵ where R³ is an aliphatic or aromatic hydrocarbon group; and
R⁴ is a hydrogen atom or an aliphatic hydrocarbon group with 1 to 6 carbon atoms.

34. The optical article of claim 23, wherein second component B comprises a compound of formula: 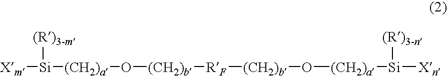
wherein
R′_{F} is a linear chain divalent perfluoropolyether radical;
R′ is an alkyl radical in C1-C4 or a phenyl radical;
X′ is a hydrolysable group;
a′ is an integer from 0 to 2;
b′ is an integer from 1 to 5; and
m′ and n′ are integers equal to 2 or 3.

35. The optical article of claim 34, wherein:
the hydrolysable groups X′ are halogen atoms, —OR³, —OCOR³, —OC(R³)═C(R⁴)₂, —ON═C(R³)₂ and/or —ON═CR⁵ where R³ is an aliphatic or aromatic hydrocarbon group; and
R⁴ is a hydrogen atom or an aliphatic hydrocarbon group with 1 to 6 carbon atoms.

36. The optical article of claim 23, wherein the anti-smudge coating has a surface energy of 14 mJ/m² or less.

37. The optical article of claim 36, wherein the anti-smudge coating has a surface energy of 12 mJ/m² or less.

38. The optical article of claim 23, wherein the anti-smudge coating is at least partially covered by a temporary topcoat.

39. The optical article of claim 38, wherein the temporary topcoat is an inorganic layer comprised of one or several metal fluorides and/or one or several metal oxides.

40. The optical article of claim 38, wherein the temporary topcoat is made of a polymer material.

41. The optical article of claim 39, wherein the temporary topcoat has a surface energy equal to or over 15 mJ/m².

42. The optical article of claim 23, wherein the anti-smudge coating is directly on a multilayer anti-reflective coating comprising an outermost layer comprising SiO₂ and the anti-smudge coating is formed directly on this outermost layer of the antireflective coating.

43. The optical article of claim 23, further defined as an ophthalmic lens.

44. A method comprising:
obtaining an optical article of claim 23 with the anti-smudge coating at least partially covered by a temporary topcoat;
edging the optical article; and
removing the temporary topcoat.

45. An optical article comprising an optically transparent substrate with a main surface and an anti-smudge coating covering the main surface, wherein the anti-smudge coating is the result of the hardening of a polymerizable composition comprising:
55% to 80% by weight of a first component A selected from fluorinated compounds of which only one end comprises at least one silanol group or silanol precursor or mixture of such compounds; and
45% to 20% by weight of a second component B selected from linear fluorinated compounds of which both ends comprise at least one silanol group or silanol precursor or mixture of such compounds, relative to the weight of compounds A and B comprised in said polymerizable composition;
wherein first component A and second component B together account for at least 50% by weight of the total weight of the coating, and wherein the anti-smudge coating has been at least partially covered by a temporary topcoat, which has then been removed.
